(19) United States
(12) Patent Application Publication
(10) Pub. No.: US 2015/0245170 A1
(43) Pub. Date: Aug. 27, 2015

(54) APPARATUS AND METHOD FOR SECURING AVAILABLE FREQUENCY

(71) Applicant: ELECTRONICS AND TELECOMMUNICATIONS RESEARCH INSTITUTE, Daejeon (KR)

(72) Inventors: Sang In CHO, Daejeon (KR); Sung Jin YOO, Daejeon (KR); Byung Jang JEONG, Daejeon (KR)

(21) Appl. No.: 14/601,376

(22) Filed: Jan. 21, 2015

(30) Foreign Application Priority Data
Feb. 24, 2014 (KR) 10-2014-0021454

(51) Int. Cl. H04W 4/02; H04B 1/10; H04B 1/04

(52) U.S. Cl. CPC H04W 4/02; H04B 1/0475; H04B 1/10

(57) ABSTRACT

Disclosed are an apparatus and a method for securing an available frequency that secure a frequency in a communication area set so as not to overlap with a service protection area of a primary user as an available frequency to prevent interference with the primary user even in the case of communicating with a frequency sharing wireless apparatus without a positioning function.

To this end, the apparatus for securing an available frequency includes: a storage unit storing positional information regarding a primary user protection area and information on a frequency for each communication area; a positioning unit measuring a current position; and a control unit calculating a spacing distance from the primary user protection area based on the current position measured by the positioning unit and securing a frequency which does not exceed the calculated spacing distance as an available frequency.

### CROSS-REFERENCE TO RELATED APPLICATIONS

This application claims priority to and the benefit of Korean Patent Application No. 10-2014-0021454 filed in the Korean Intellectual Property Office on Feb. 24, 2014, the entire contents of which are incorporated herein by reference.

### TECHNICAL FIELD

The present invention relates to an apparatus and a method for securing an available frequency, and more particularly, to a technology that secures an available frequency to prevent frequency interference in a primary user, which occurs by a first wireless apparatus in a frequency sharing wireless apparatus having a positioning function, which communicates with a frequency sharing wireless apparatus (hereinafter, a first wireless apparatus) without the positioning function.

### BACKGROUND ART

The frequency sharing wireless apparatus represents a wireless apparatus that allows a secondary user (sub user) to commonly use a frequency band used by a primary user (main user). In this case, the secondary user should not cause interference in communication of the primary user. That is, a frequency sharing wireless apparatus of the secondary user, which uses a TV white space should not cause interference with a DTV receiver of the primary user who receives a DTV service through a TV band.

In order not to cause the interference in the DTV service, the apparatus should be used with a protection spacing distance so as to prevent a transmitted radio wave of the frequency sharing wireless apparatus of the secondary user from reaching a position of the primary user.

FIG. 1 is an explanatory diagram of an exemplary embodiment of a position based available frequency securing method in the related art.

In FIG. 1, the primary user becomes DTV receivers 105 and 106 and the secondary user becomes a TV band device (TVBD1) 400. Therefore, the TVBD1 400 as the secondary user should not cause interference with the DTV receivers 105 and 106 which are the primary user.

A DTV transmitting station 100 is positioned at a high location to transmit a DTV signal, the signal is propagated to (101) up to home DTV antennas 103 and 104 at a boundary point of a broadcasting area 102 and the DTV receivers 105 and 106 with the DTV antennas 103 and 104 provide the DTV service to viewers. In this case, the apparatus is used with a protection spacing distance 300 so that the signal from the TVBD1 400 does not cause interference with the DTV receivers 105 and 106.

In the available frequency securing method in the related art, a frequency in a communication area 401 of the TVBD1 400 which is set so as not to overlap with the broadcasting area 102 of the primary user is secured as the available frequency.

However, as illustrated in FIG. 2, the available frequency securing method in the related art has a problem that when a TVBD2 500 without the positioning function is positioned in a protection area, the DTV receiver 106 is included in a communication area 501 of the TVBD2 500 to interfere with the DTV receiver 106.

### SUMMARY OF THE INVENTION

The present invention has been made in an effort to provide an apparatus and a method for securing an available frequency that secure a frequency in a communication area set so as not to overlap with a service protection area of a primary user as an available frequency to prevent interference with the primary user even in the case of communicating with a frequency sharing wireless apparatus without a positioning function.

An exemplary embodiment of the present invention provides an apparatus for securing an available frequency including: a storage unit storing positional information regarding a primary user protection area and information on a frequency for each communication area; a positioning unit measuring a current position; and a control unit calculating a spacing distance from the primary user protection area based on the current position measured by the positioning unit and securing a frequency which does not exceed the calculated spacing distance as an available frequency.

Another exemplary embodiment of the present invention provides a method for securing an available frequency including: storing, by a storage unit, positional information regarding a primary user protection area and information on a frequency for each communication area; measuring, by a positioning unit, a current position; and calculating, by a control unit, a spacing distance from the primary user protection area based on the current position and securing a frequency which does not exceed the calculated spacing distance as an available frequency.

According to exemplary embodiments of the present invention, a frequency in a communication area set so as not to overlap with a service protection area of a primary user is secured as an available frequency to prevent interference with the primary user even in the case of communicating with a frequency sharing wireless apparatus without a positioning function.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

Objects of the present invention are not limited the aforementioned object and other objects and advantages of the present invention, which are not mentioned can be appreciated by the following description and will be more apparently know by the exemplary embodiments of the present invention. It can be easily known that the objects and advantages of the present invention can be implemented by the means and a combination thereof described in the appended claims.

### BRIEF DESCRIPTION OF THE DRAWINGS

FIG. 1 is an explanatory diagram of an exemplary embodiment of a position based available frequency securing method in the related art.

FIG. 2 is an explanatory diagram of an exemplary embodiment for describing a problem in the position based available frequency securing method in the related art.

FIG. 3 is an explanatory diagram of an exemplary embodiment of a scheme for securing an available frequency according to the present invention.

FIG. 4 is a configuration diagram of an exemplary embodiment of an apparatus for securing an available frequency according to the present invention.

FIG. 5 is a flowchart of an exemplary embodiment of a method for securing an available frequency according to the present invention.

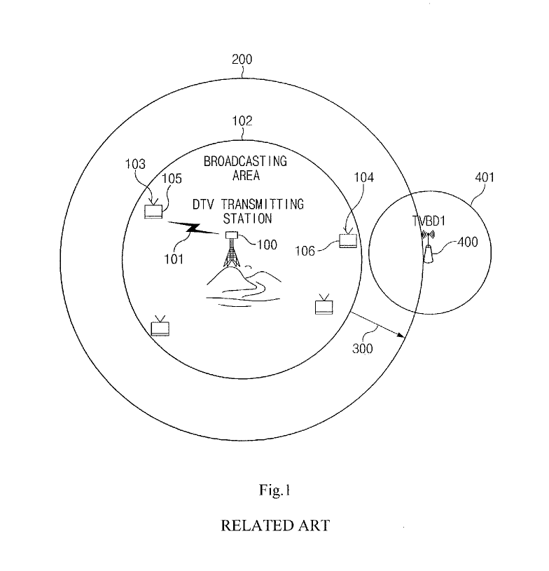

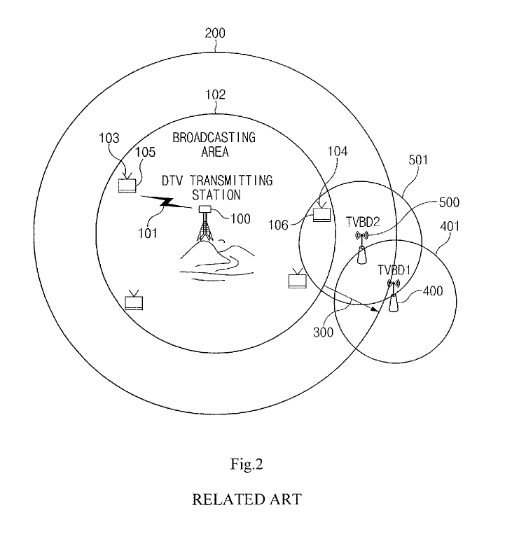

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The aforementioned objects, characteristics, and advantages will be more apparent through the detailed description below related to the accompanying drawings, and thus those skilled in the art to which the present invention pertains will easily implement the technical spirit of the present invention. In the following description, a detailed explanation of known related functions and constitutions may be omitted so as to avoid unnecessarily obscuring the subject matter of the present invention. Hereinafter, exemplary embodiments according to the present invention will be described with reference to the accompanying drawings in detail.

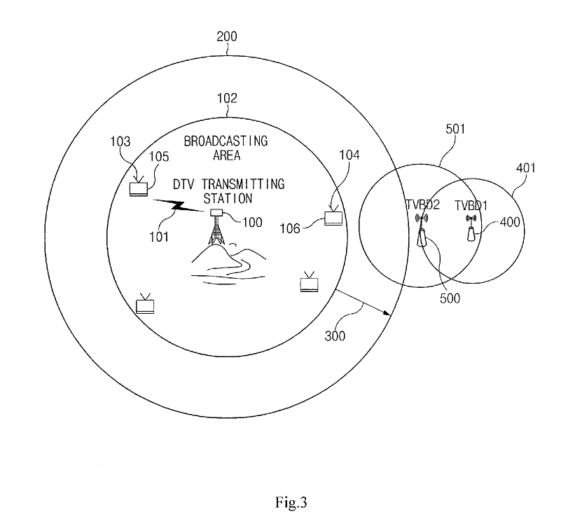

FIG. 3 is an explanatory diagram of an exemplary embodiment of a scheme for securing an available frequency according to the present invention.

As illustrated in FIG. 3, a TVBD1 400 which is a secondary user sets a communication area 401 which does not overlap with a DTV service protection area 200 and secures a frequency in the communication area 401 as an available frequency. In this case, the TVBD1 400 has a positioning function.

Thereafter, the TVBD1 400 communicates with a TVBD2 500 without the positioning function and in this case, it can be seen that the TVBD2 500 which is the secondary user does not interfere with a DTV receiver 106 which is a primary user.

The reason is that the TVBD1 400 secures the available frequency so that the DTV receiver 106 is not included in a communication area 501 of the TVBD2 500.

When the TVBD2 500 is positioned in the DTV service protection area 200, the TVBD2 500 deviates from the communication area 401 of the TVBD1 400, and as a result, the TVBD2 500 may not communicate with the TVBD1 400.

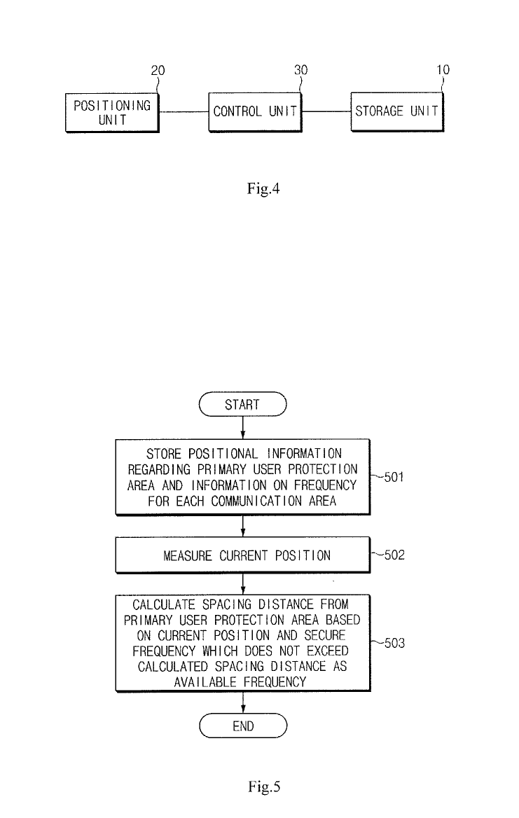

FIG. 4 is a configuration diagram of an exemplary embodiment of an apparatus for securing an available frequency according to the present invention.

As illustrated in FIG. 4, the apparatus for securing an available frequency according to the present invention includes a storage unit 10, a positioning unit 20, and a control unit 30.

In regard to the components, first, the storage unit 10 stores various pieces of information (a position, and the like) on a primary user protection area and information on a frequency for each communication area. Herein, the primary user protection area may be the DTV service protection area, as one example, and the frequency for each communication area means a frequency (channel) having a predetermined communication area.

The positioning unit 20 is a GPS receiver as one example and acquires current positional information.

The control unit 30 calculates a spacing distance from the primary user protection area based on a current position measured by the positioning unit 20.

Thereafter, the control unit 30 secures a frequency which does not exceed the calculated spacing distance as the available frequency.

That is, the control unit 30 sets the communication area so as not to overlap with the primary user protection area and thereafter, secures the frequency in the set communication area as the available frequency.

The apparatus for securing an available frequency according to the present invention may be applied to a frequency sharing wireless apparatus and the frequency sharing wireless apparatus communicates with another frequency sharing wireless apparatus, in particular, another frequency sharing wireless apparatus without the positioning function based on the available frequency secured by the available frequency securing apparatus according to the present invention. In this case, the other frequency sharing wireless apparatus without the positioning function does not cause interference with the primary user.

FIG. 5 is a flowchart of an exemplary embodiment of a method for securing an available frequency according to the present invention.

First, a storage unit 10 stores positional information regarding a primary user protection area and information on a frequency for each communication area (501).

Thereafter, a positioning unit 20 measures a current position (502).

Thereafter, a control unit 30 calculates a spacing distance from the primary user protection area based on the current position measured by the positioning unit 20 and secures a frequency which does not exceed the calculated spacing distance as an available frequency (503).

Through such a process, interference with a primary user may be prevented even when communicating with a frequency sharing wireless apparatus without a positioning function.

Meanwhile, the aforementioned method of the present invention can be prepared by a computer program. Codes and code segments constituting the program can be easily deduced by a computer programmer skilled in the art. The prepared program is stored in a computer readable recording medium (information storage medium) and is read and executed by a computer to implement the method of the present invention. The recording medium includes all types of computer readable recording media.

Various exemplary embodiments of the present invention have been just exemplarily described, and various changes and modifications may be made by those skilled in the art to which the present invention pertains without departing from the scope and spirit of the present invention. Accordingly, the embodiments disclosed herein are intended not to limit but to describe the technical spirit of the present invention, and the scope of the technical spirit of the present invention is not limited to the embodiments. The scope of the present invention may be interpreted by the appended claims and all the technical spirit in the equivalent range thereto are intended to be embraced by the claims of the present invention.

What is claimed is:

1. An apparatus for securing an available frequency, the apparatus comprising:
a storage unit storing positional information regarding a primary user protection area and information on a frequency for each communication area;
a positioning unit measuring a current position; and
a control unit calculating a spacing distance from the primary user protection area based on the current position measured by the positioning unit and securing a frequency which does not exceed the calculated spacing distance as an available frequency.

2. The apparatus of claim 1, wherein the control unit sets a communication area so as not to overlap with the primary user protection area and thereafter, secures the frequency in the set communication area as the available frequency.

3. The apparatus of claim 1, wherein the primary user is a DTV service.

4. A method for securing an available frequency, the method comprising:
storing, by a storage unit, positional information regarding a primary user protection area and information on a frequency for each communication area;
measuring, by a positioning unit, a current position; and
calculating, by a control unit, a spacing distance from the primary user protection area based on the current position and securing a frequency which does not exceed the calculated spacing distance as an available frequency.

5. The method of claim 4, wherein in the securing of the available frequency, a communication area is set so as not to overlap with the primary user protection area and thereafter, the frequency in the set communication area is secured as the available frequency.

6. The method of claim 4, wherein the primary user is a DTV service.
